(19) United States
(12) Patent Application Publication
(10) Pub. No.: US 2004/0064558 A1
(43) Pub. Date: Apr. 1, 2004

(54) Resource distribution management method over inter-networks

(75) Inventor: Shigeru Miyake, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Ltd., Tokyo (JP)

(21) Appl. No.: 10/255,749

(22) Filed: Sep. 26, 2002

(51) Int. Cl. G06F 15/173

(52) U.S. Cl. 709/226

(57) ABSTRACT

A system for facilitating optimal utilization of resources across multiple management domains is provided. A system management (SM) server is located at each management domain. The SM server is able to perform a number of functions, such as, managing the resources within the associated management domain and communicating with other SM servers from other management domains. Furthermore, the SM server is able to receive and process a request specifying resources that are needed for a particular job or process. The SM server may receive the request directly from a user or from another SM server. Upon receiving the request, the SM server determines whether the request can be satisfied using resources from its own management domain as well as resources from other management domains, where appropriate. If resources from another management domain are needed, the SM server contacts the corresponding SM server of the other management domain and begins a negotiation process in order to secure the needed resources from the other management domain. Various details may be negotiated between the two SM servers including, for example, type and amount of resources needed, performance criteria and bandwidth requirements.

### CROSS-REFERENCES TO RELATED APPLICATION(S)

The present application is related to co-pending, commonly assigned and owned U.S. patent application Ser. No. [to be assigned] entitled “INTEGRATED TOPOLOGY MANAGEMENT METHOD FOR STORAGE AREA AND IP NETWORKS”, filed concurrently herewith, the disclosure of which is hereby incorporated by reference in its entirety for all purposes.

### BACKGROUND OF THE INVENTION

The present invention generally relates to storage area networks. More specifically, the present invention relates to methods and systems for improving resource utilization in storage area networks.

In a typical computer system, network management and storage management are usually performed separately by different sets of dedicated management tools. System administrators, especially those who are in charge of network management, have to understand and recognize all the connections between network nodes including routers, switches, servers, client PCs and storage nodes. While network management tools are generally available for IP networks, these tools cannot be used to manage networks that do not utilize IP protocol. Such network management tools typically can be used to perform various network management functions, such as, displaying the topology of a network for purposes of managing the network faults and configurations and showing the network topology regarding physical connections in multi-windows.

With respect to storage management, a storage sub-system is typically attached to and controlled by a server computer. Management of the storage sub-system has generally been subsumed as one of the many management functions performed by the server computer. As a result, storage management, such as, data management functions, is typically supported by most system management tools utilized by the server computer. Typical storage management tools can only manage storage and fiber channel network port connections. Until recently, management of the storage sub-system has been limited locally to within a computer system. That is because elements of the storage sub-system are not distributed over multiple computer networks. Other management functions regarding device management, however, have not been provided by most system management tools.

Due to the continued proliferation of information at different geographic locations, information is increasingly stored on a distributed basis thereby leading to the development of storage area networks (SANs). SANs allow information stored at distributed locations to be shared over computer networks. SAN management tools have been developed and are available to manage SANs. However, these SAN management tools primarily provide functions for managing storage related devices, such as, disk allays (RAID), fibre channel adapters and fabric switch equipment.

In addition, new transport protocols, such as, SCSI over IP (iSCSI), Fibre Channel over IP (FCIP) and internet Fibre Channel Protocol (iFCP) have been recently developed to further enable and facilitate implementation of SANs. So far, management tools for Fibre Channel networks have been developed in order to manage the configuration of Fibre Channel switch equipment. Also, management information definitions for iSCSI and iFCP have been published as draft standard documents by the Internet Engineering Task Force (IETF) and the Storage Networking Industry Association (SNIA). These block transport based protocol over TCP/IP are suitable for data communication network among servers and storage devices. Since these recently developed protocols are stacked over the IP protocol, new management method is needed in order to manage an environment that utilizes a mixture of regular IP protocol and these new protocols over IP.

Furthermore, as previously mentioned, information may need to be stored and distributed across a number of storage area networks. For communications conducted over a global network, such as, the Internet, assurance of adequate bandwidth is one of the key metrics used to control quality of service (QoS) in order to allow information to be accessed and retrieved in a timely and efficient manner. QoS control is particularly important for network service providers that need to accommodate critical transactions. Similarly, high QoS is often desired for other service providers (xSPs), such as, storage service providers (SSP), management service providers (MSP) and so on.

While a number of solutions currently exist that permit QoS to be maintained for network communications, there are some other issues that need to be resolved in order to provide QoS-assured end-to-end service for xSPs. QoS control techniques and methodologies, such as, Resource Reservation Protocol (RSVP), Differentiated Service Protocol and policy servers for these respective protocols have been discussed. For example, the specifications of these QoS techniques and methodologies are published by the IETF. In addition, policy schemata for storage management systems are also being developed by SNIA. Nevertheless, techniques and methodologies for bridging communications between storage area networks and IP networks are still virtually non-existent.

Hence, it would be desirable to have a method and system that is capable of facilitating resource utilization across various nodes with each node having at least one storage area network and an IP network.

### SUMMARY OF THE INVENTION

An exemplary embodiment of the present invention is a set of integrated management tools that is capable of providing integrated management of IP network nodes and storage network nodes, such as, a SAN.

According to one exemplary embodiment, the set of integrated management tools is implemented using software in a modular manner. More specifically, the set of integrated management tools includes a number of modules including a SNMP manager module, a management map creation module, a storage network topology information creation module, an IP storage configuration module, a FC configuration module, a RAID configuration module, and a HBA configuration module.

The SNMP manager module is responsible for carrying out various SNMP (simple network management protocol) functions, such as, handling SNMP packets and MIB (management information base) contents acquired from managed objects.

The management map creation module is responsible for managing various network or node mapping functions, such as, creating, storing and displaying the given topology information of a network or node.

The storage network topology information creation module is responsible for creating and managing storage device specific network information. For example, network information that relates to specific protocols, such as, Fibre Channel and iSCSI, for different storage devices can be created and managed by this module.

The IP storage configuration module is responsible for managing information relating to IP storage configuration. For example, this module can be used to change or query IP storage configuration relating to a network or node.

The FC configuration module is responsible for managing information relating to FC (Fibre Channel) storage configuration. For example, this module can be used to change or query the FC storage configuration relating to a network or node.

The RAID configuration module is responsible for managing information relating to RAID (redundant arrays of inexpensive disks) device configuration. For example, this module can be used to change or query the RAID device configuration relating to a network or node.

The HBA configuration module is responsible for managing information relating to HBA (host bus adapter) device configuration. For example, this module can be used to change or query the HBA and client device configuration relating to a network or node.

In one exemplary embodiment, these modules are deployed in a distributed manner within a networked system having a number of nodes. Each node includes an IP server farm and a storage sub-system or network, such as, a SAN. Some of the nodes respectively include a local storage management (LSM) server. Some of the modules within the set of integrated management tools reside on the LSM server. For example, the SNMP manager module, portions of the management map creation module, the storage network topology information creation module, the IP storage configuration module, the FC configuration module, the RAID configuration module, and the HBA configuration module may reside on the LSM server. One node within the networked system includes a global storage management (GSM) server. Portions of the management map creation module resides on the GSM server. The GSM server communicates with the various LSM servers to facilitate control and management of the various nodes.

The present invention can be generally used for managing network oriented systems with networked storage subsystems for handling large volumes of data. For example, the present invention can be used by data centers, enterprise information infrastructures and storage service providers to facilitate handling and storage of voluminous amount of data across the entire system. Using the present invention, system administrators can reduce the cost of system and network operations significantly, especially the cost of managing operations related to networked storage with multiple storage-related protocols. Based on the disclosure and teachings provided herein, a person of ordinary skill in the art will realize other applications, advantages, and benefits of the present invention.

Another exemplary embodiment of the present invention includes a system for facilitating optimal utilization of resources across multiple management domains is provided. The system further includes a system management (SM) server located at each management domain. The SM server is able to perform a number of functions, such as, managing the resources within the associated management domain and communicating with other SM servers from other management domains. Furthermore, the SM server is able to receive and process a request specifying resources that are needed for a particular job or process.

The SM server may receive the request directly from a user or from another SM server. Upon receiving the request, the SM server determines whether the request can be satisfied using resources from its own management domain as well as resources from other management domains, where appropriate. If resources from another management domain are needed, the SM server contacts the corresponding SM server of the other management domain and begins a negotiation process in order to secure the needed resources from the other management domain. Various details may be negotiated between the two SM servers including, for example, type and amount of resources needed, performance criteria and bandwidth requirements.

In one exemplary embodiment, the SM server has a number of components or modules including a communication manager, a policy server, a resource manager and a resource database.

The communication manager coordinates and controls communications amongst various resources within the associated management domain and also handles communications with other communication managers to handle incoming and outgoing communications with other management domains.

The policy server evaluates any request initiated by a user, such as a system administrator, requesting resources for a particular job or process and determines whether and how the request can be satisfied. In addition, the policy server also evaluates any request received from a requesting SM server and facilitates the negotiation process with the requesting SM server to determine the available resources, if any, that are to be offered to satisfy the request and finalize the resource assignment plan. The policy server further executes the resource assignment plan to deploy the assigned resources within the associated management domain.

The resource manager is capable of managing both network and storage resources. With respect to managing network resources, the resource manager monitors and controls all the network and network-related resources within the associated management domain and maintains the corresponding network information, such as, routing and utilization information. With respect to managing storage resources, the resource manager monitors and controls all the storage and storage-related resources within the associated management domain and maintains the corresponding storage information, such as, access path control, routing and capacity information. In order to interact with the resource manager or other modules within the SM server, some of the resources within the management domain may need to be modified to include functions that allow the SM server to ascertain the status information of these resources. For example, a storage node may include functions that notify the SM server when certain conditions or events occur, such as, device failure, configuration change or capacity overflow, etc.

The resource database is a database that is used to store information and data utilized by the various modules of the SM server.

The present invention may be used by xSP such as ISP, SSP and MSP, as a QoS control method for network service especially for critical transactions conducted via the Internet. Using the present invention, xSP can provide assured end-to-end service to their consumer with Internet QoS assured technologies.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified schematic diagram illustrating an exemplary embodiment in accordance with the present invention;

FIG. 2 is a simplified schematic diagram illustrating an exemplary conceptual architecture of the integrated system management tools in accordance with the present invention;

FIG. 3 is a simplified schematic diagram illustrating an exemplary embodiment of the integrated management tools in accordance with the present invention;

FIG. 4 is an exemplary flow diagram illustrating the discovery process for storage-related devices in accordance with the present invention;

FIGS. 5A-C illustrate exemplary types of device and topology information that is forwarded by a LSM server to a GSM server in accordance with the present invention;

FIGS. 6A-G illustrate additional exemplary types of device and topology information that forwarded by a LSM server to a GSM server in accordance with the present invention;

FIG. 7 is a simplified schematic diagram illustrating the operations of one exemplary embodiment of the present invention;

FIG. 8 is a simplified schematic diagram illustrating an exemplary embodiment of a SM server in accordance with the present invention;

FIG. 9 is a simplified schematic diagram illustrating an exemplary embodiment of a policy server in accordance with the present invention;

FIG. 10 is a simplified schematic diagram illustrating some of the exemplary functions performed by a policy server, a resource manager and a communication manager and the respective databases with which they interact in accordance with the present invention;

FIG. 11 is an illustrative diagram showing a sample request message that is forwarded by one SM server to another SM server requesting additional resources in accordance with the present invention;

FIG. 12 is an illustrative diagram showing an advertisement message that is broadcasted by a requesting SM server to other SM servers requesting additional resources in accordance with the present invention; and

FIG. 13 is a flow diagram illustrating an exemplary process under which resource requests are satisfied in accordance with the present invention.

### DETAILED DESCRIPTION OF THE INVENTION

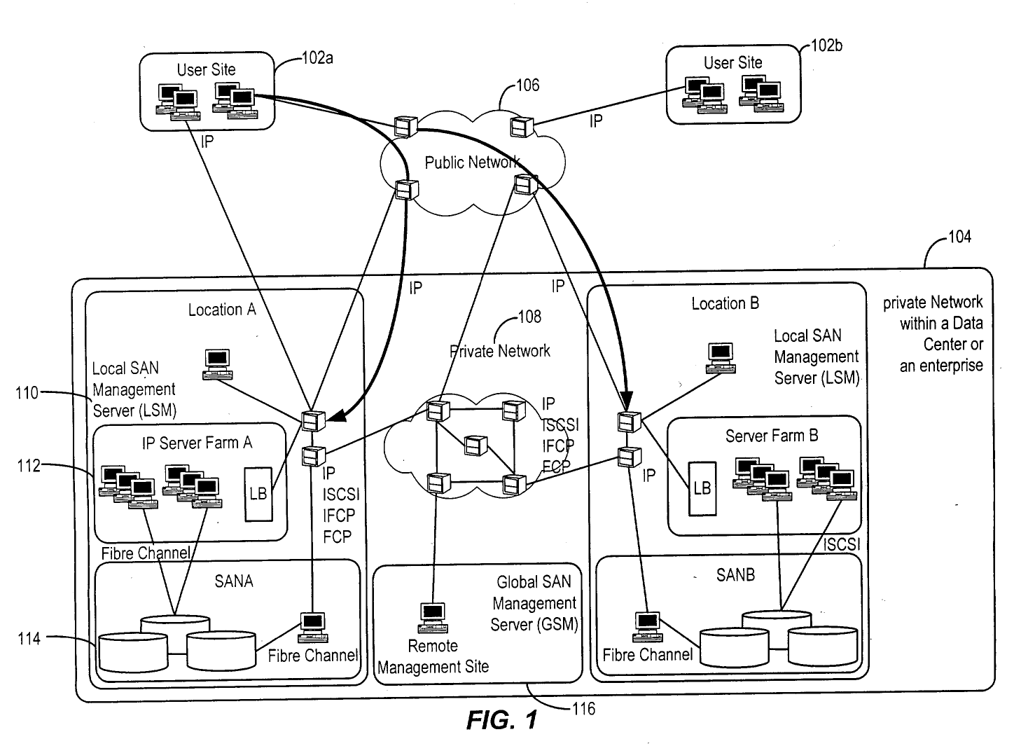

The present invention in the form of one or more exemplary embodiments will now be described. FIG. 1 shows an exemplary embodiment of a system 100 in accordance with the present invention. Referring to FIG. 1, the system 100 includes a number of user/client sites 102a and 102b and a back-end system 104. The client sites 102a and 102b are able to communicate with the back-end system 104 via either a public computer network 106, such as, the Internet, or a direct link, such as, a dialup connection.

In one exemplary embodiment, the back-end system 104 is a private network system managed by a data center or an enterprise IT management division within a company. The back-end system 104 is a distributed system that further includes groups of components or devices located at various different geographical locations. For example, location A may include a group of components. The group of components includes a local storage management (LSM) server 110, an IP network node including a server farm 112, and a storage network node including a SAN 114. At location A, the LSM server 110 is responsible for managing the server farm 112 and the SAN 114 within that location. The group of components may further include other computing elements or devices that are used to facilitate communications with other external devices, such as, the user/client site 102a. Likewise, location B may include a similar group of components providing similar functionality.

These different groups of components at various locations communicate with one another via a private computer network 108. The communications via the private computer network 108 are controlled by a global storage management (GSM) server 116. Generally, the GSM server 116 is located in a location that is different from the LSM servers 110. However, it should be noted that the GSM server 116 may also be located in the same location as one of the LSM servers 110. The functions of the GSM server 116 and the LSM servers 110 and their interactions will be further described below.

Within the back-end system 104, many types and layers of protocols, such as, Fibre Channel, IP and iSCSI, may be used concurrently to implement different parts of the back-end system 104.

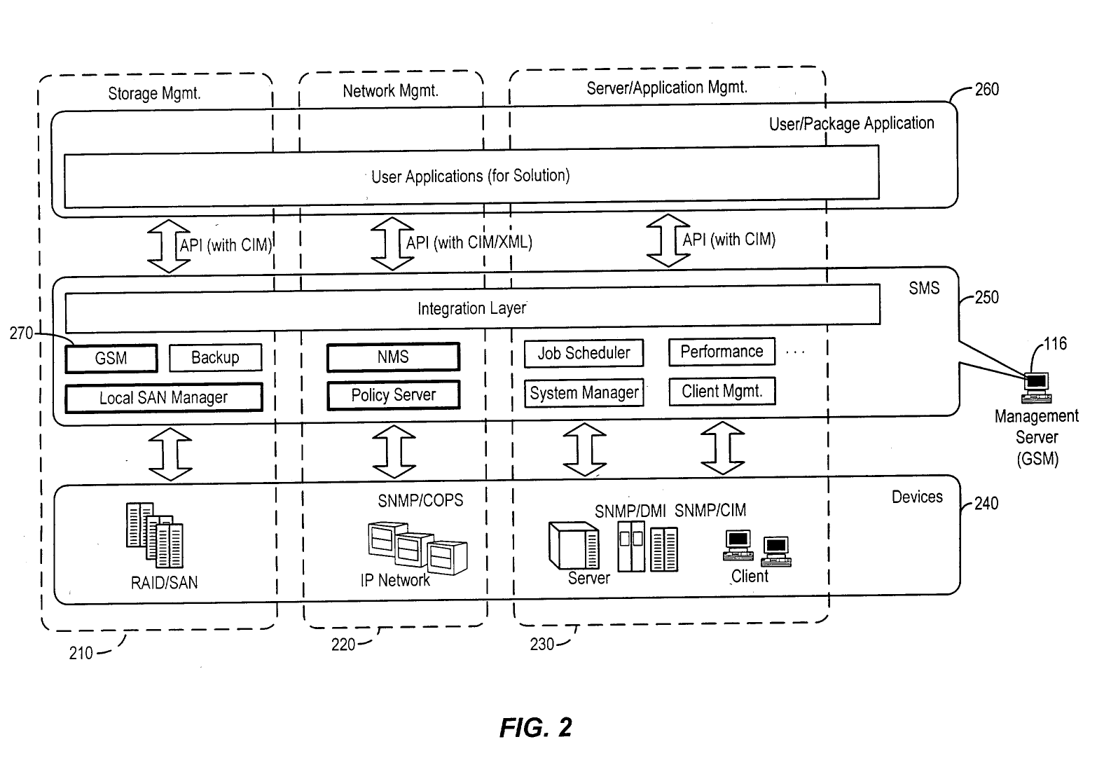

FIG. 2 illustrates an exemplary conceptual architecture of the integrated system management tools in accordance with the present invention. The integrated system management tools can be used to manage different aspects of the back-end system 104, including storage management, network management and server/application management.

From another perspective, the integrated management tools can be viewed as having three layers, namely, a device layer 240, a systems management systems (SMS) layer 250, and a package application layer 260.

The device layer 240 includes target devices or components that are treated by the integrated management tools as managed objects. For example, the integrated system management tools can be used to manage various types of devices or components within the back-end system 104. These various types of devices or components include, for example, servers and clients 230, IP network nodes 220 and storage nodes 210 such as RAID and SAN nodes.

The SMS layer is responsible for collecting device information from all devices or components within the device layer 240 as well as the topology (or connection) information relating to each device. The device information includes different types of information including, for example, device identification information and device utilization information. For instance, the device information for a specific device may indicate that the device is a SAN having a current utilized capacity of 50% and the topology information may indicate how the SAN is connected to a server farm, for example, via Fibre Channel protocol. Based on the disclosure provided herein, a person of ordinary skill in the art will know of the different types of information that can be included as part of the device and topology information. The SMS layer further includes an integration layer 270. The integration layer 270 is responsible for integrating all the device and topology information and providing the management functions to facilitate management of all the devices across the entire system based on the integrated device and topology information. For example, if a client wishes to access a particular server within a server farm, the integration layer 270 utilizing the integrated device and topology information identifies the port that is available on the particular server and allows the client to communicate with the particular server via that available port. In another example, if data is to be stored on the system, the integration layer 270 utilizing the integrated device and topology information locates the storage devices that have the needed capacity and accordingly directs the data to be stored on the appropriate storage devices.

The package application layer 260 allows system administrators to develop user or custom applications utilizing the management functions which are available from the SMS layer 250.

As described above, management integration is achieved at the SMS layer 250 with the integration layer 270 as shown in FIG. 2. In an exemplary embodiment, the SMS layer is implemented as part of the GSM server 116. Referring to FIG. 1, device and topology information from each location, for example, locations A and B, is communicated to the GSM server 116 from the respective LSM servers 110. For example, at location A, LSM server 110 forwards the device and topology information with respect to IP server farm 112 and SAN 114 to GSM server 116. Using the device and topology information, the GSM server 116 can communicate with the respective LSM servers 110 to allow various network and storage management functions to be carried out.

In one exemplary embodiment, each LSM server 110 includes a number of modules that allow it to communicate with the GSM server 116 and carry out various network and storage management functions. These modules include a SNMP manager module, a management map creation module, a storage network topology information creation module, an IP storage configuration module, a FC configuration module, a RAID configuration module, and a HBA configuration module.

The SNMP manager module is responsible for carrying out various SNMP (simple network management protocol) functions, such as, handling SNMP packets and MIB (management information base) contents acquired from managed objects.

The management map creation module is responsible for managing various network or node mapping functions, such as, creating, storing and displaying the given topology information of a network or node. It should be noted that parts of this module may reside on the GSM server 116.

The storage network topology information creation module is responsible for creating and managing storage device specific network information. For example, network information that relates to specific protocols, such as, Fibre Channel and iSCSI, for different storage devices can be created and managed by this module.

The IP storage configuration module is responsible for managing information relating to IP storage configuration. For example, this module can be used to change or query IP storage configuration relating to a network or node.

The FC configuration module is responsible for managing information relating to FC (Fibre Channel) storage configuration. For example, this module can be used to change or query the FC storage configuration relating to a network or node.

The RAID configuration module is responsible for managing information relating to RAID (redundant arrays of inexpensive disks) device configuration. For example, this module can be used to change or query the RAID device configuration relating to a network or node.

The HBA configuration module is responsible for managing information relating to HBA (host bus adapter) device configuration. For example, this module can be used to change or query the HBA and client device configuration relating to a network or node.

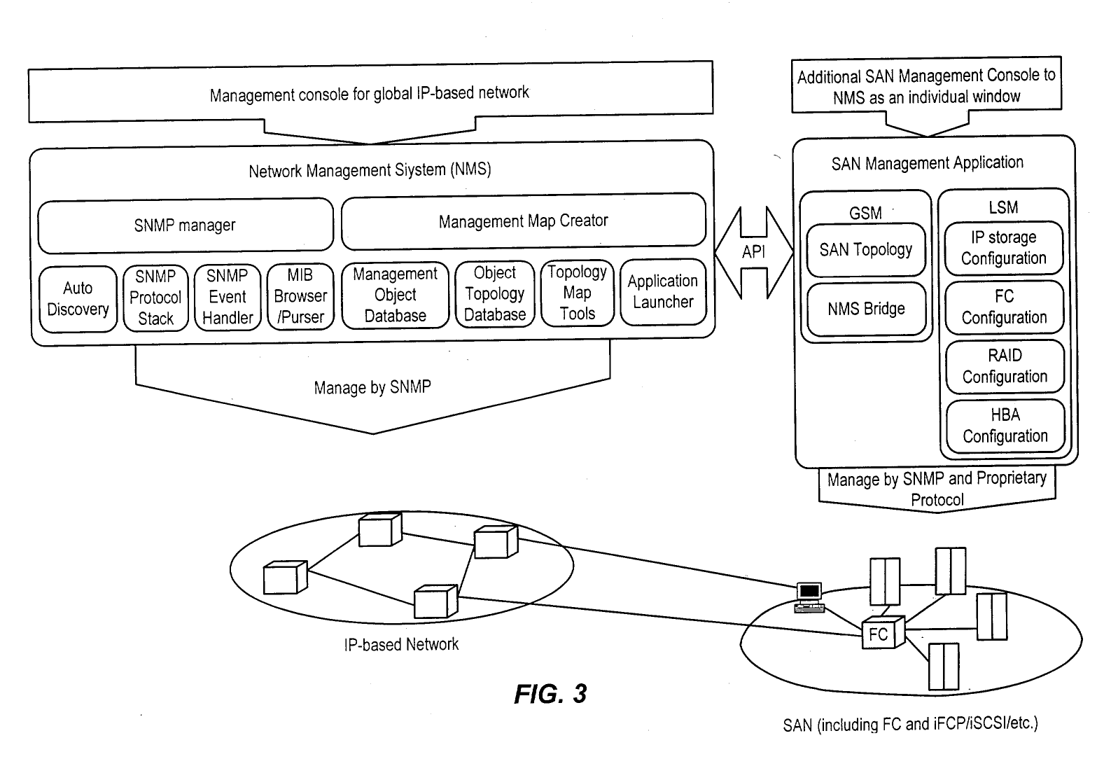

FIG. 3 illustrates an exemplary embodiment of the integrated management tools in accordance with the present invention. In this exemplary embodiment, the storage network management functionality of the integrated management tools is built or implemented as an application (hereinafter, storage network management application) that interacts with a network management system. It will be appreciated by a person of ordinary skill in the art that the network management system can be either a pre-existing system that is generally available or a system that is custom built to provide network management or a combination of both. Using the functionality of the network management system to implement the integrated management tools can help reduce the complexity and cost of the implementation process.

Referring to FIG. 3, the storage network management application of the integrated management tools is implemented using a number of modules. These modules include a SAN topology module, a NMS (network management system) bridge module, an IP storage configuration module, a FC configuration module, a RAID configuration module, and a HBA configuration module. It should be noted that since the storage network management application is implemented as an application that interacts with the network management system, the respective functionality of the SNMP manager module and the management map creation module are subsumed within the NMS bridge module. The SAN topology module corresponds to the storage network topology information creation module as described above. Finally, the IP storage configuration module, the FC configuration module, the RAID configuration module and the HBA configuration module as shown in FIG. 3 provide the same functionality as those described above. These modules are distributed between the GSM server 116 and each LSM server 110.

In the exemplary implementation shown in FIG. 3, the SAN topology module and the NMS bridge module reside on the GSM server 116 and the IP storage configuration module, the FC configuration module, the RAID configuration module, and the HBA configuration module reside on the LSM server 110. In addition, the storage network management application includes an application programmable interface (API) that can be used to communicate with various function blocks within the network management system, such as, SNMP event handler, MIB browser & purser, object topology database and topology map tools, etc.

Generally, the modules residing on the LSM server 110, as described above, provide the capability to allow the LSM server 110 to change or query the configuration of the storage or storage-related devices, such as, Fibre Channel switches, Host Bus Adapters (HBA) and IP storage drivers in the devices. The configuration or topology information may then be passed to the GSM server 116. The modules residing on the GSM server 116 may then, in turn, display such information in various manners for viewing and management purposes, as will be further discussed below.

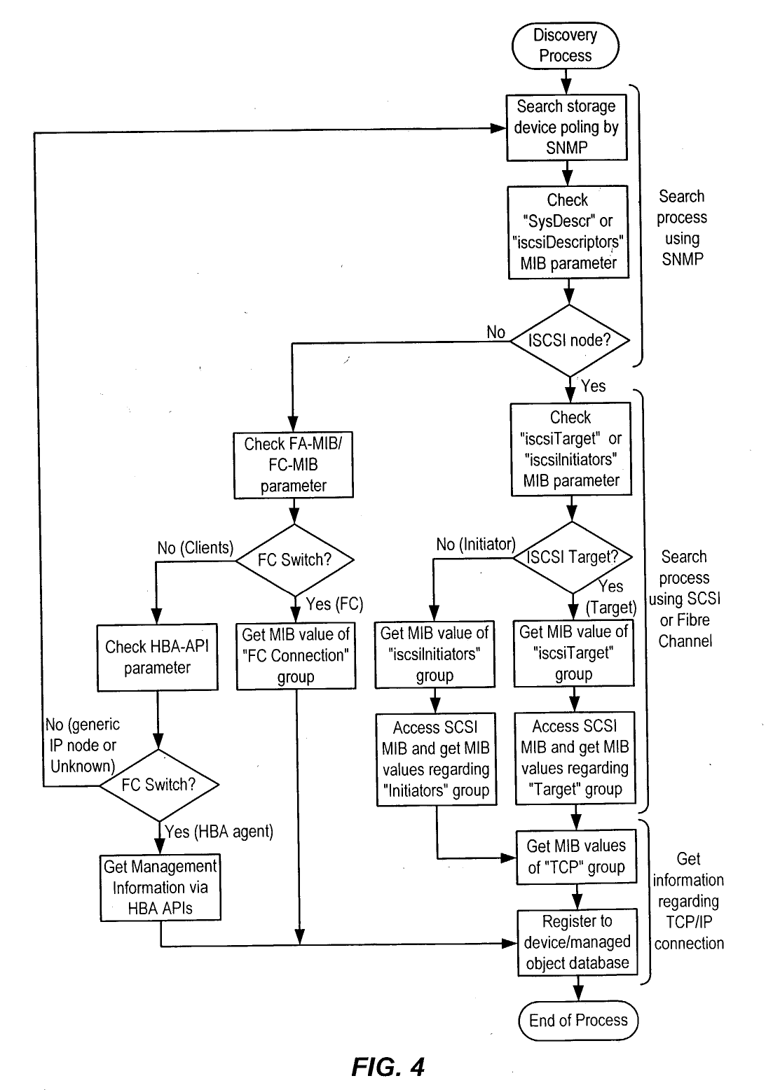

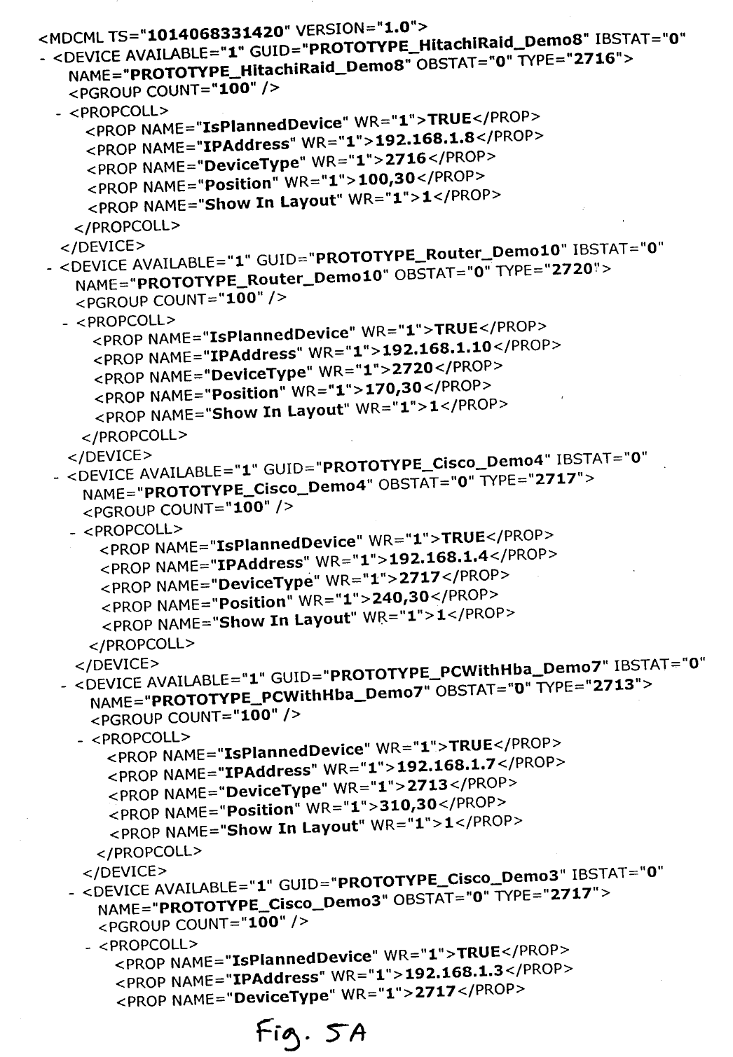

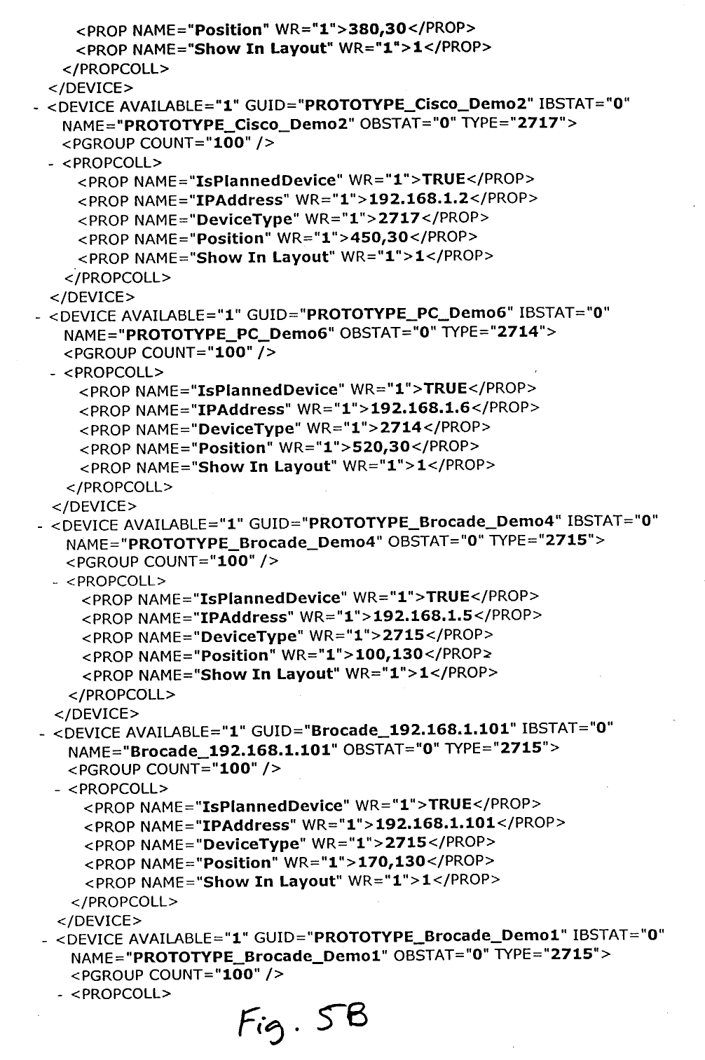

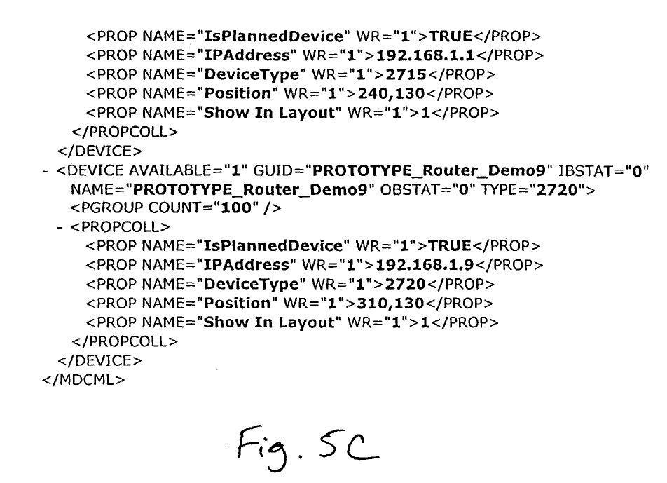

In order for the integrated management tools to provide the functionality described above, all the managed devices within the system and their associated information need to be identified or discovered. More specifically, first, all the nodes within the system are polled and identified to determine whether a node is an IP network node or a storage network node. Once the initial identity of a node is identified, appropriate steps are taken to further determine what devices are within that node. For example, if it is determined that a node is a storage network node, then an additional check is performed to determine if that storage network node is a iSCSI node or a Fibre Channel node. Depending on the outcome of this determination, appropriate steps are taken to identify the devices or equipment within that node. Details of the discovery process are illustrated in FIG. 4. FIG. 4 is an exemplary flow diagram illustrating the discovery process for storage-related devices in accordance with the present invention. Based on the disclosure provided herein, a person of ordinary skill in the art will be able to carry out the discovery process in accordance with the present invention.

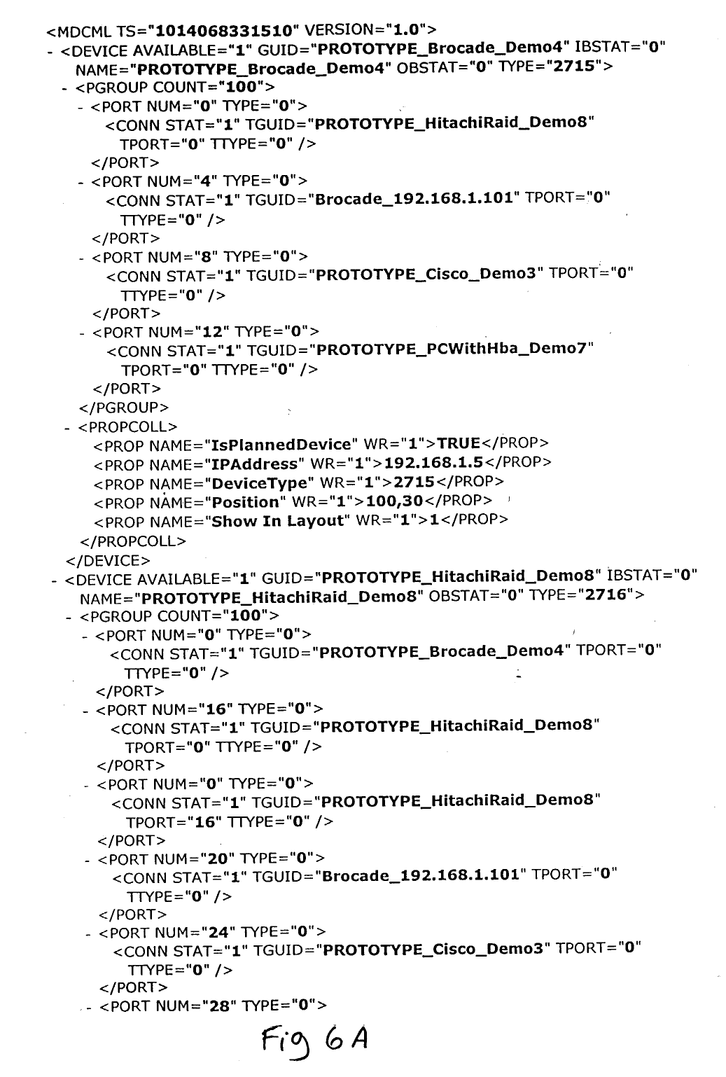

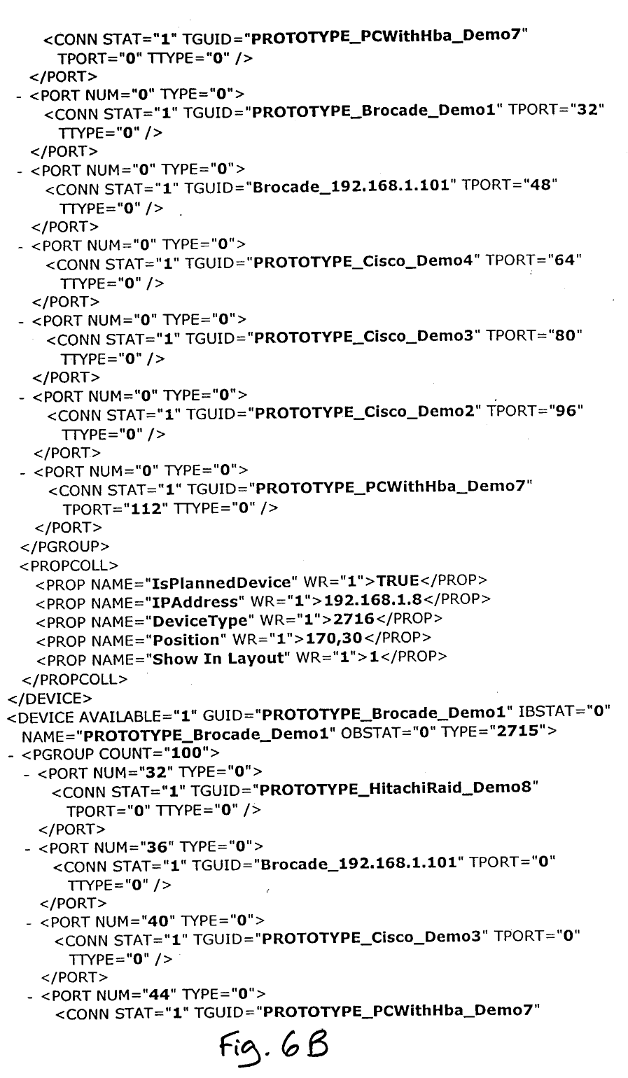

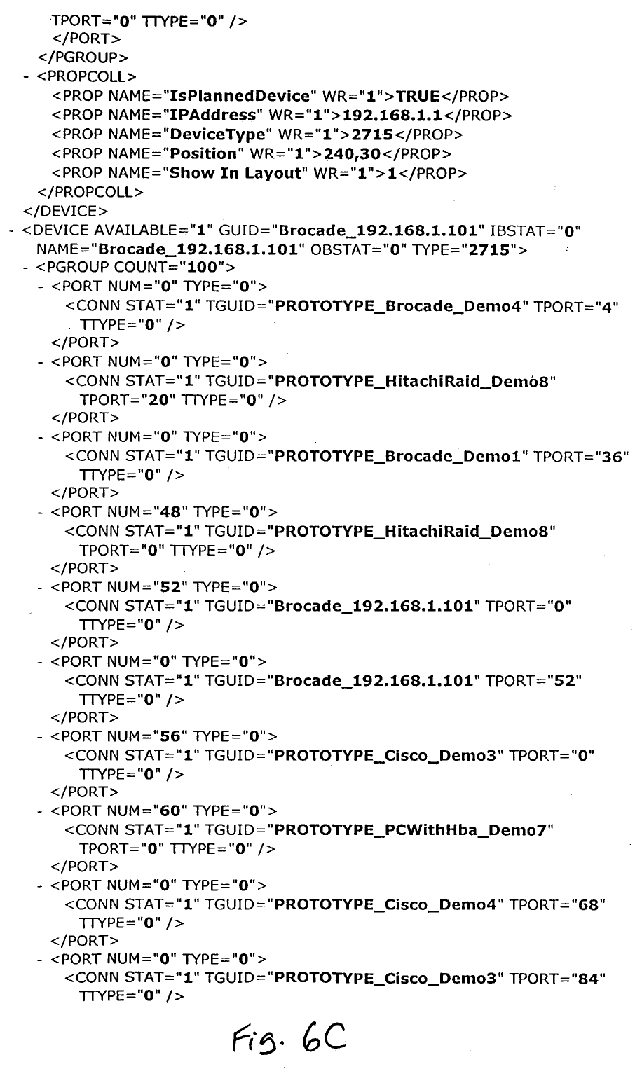

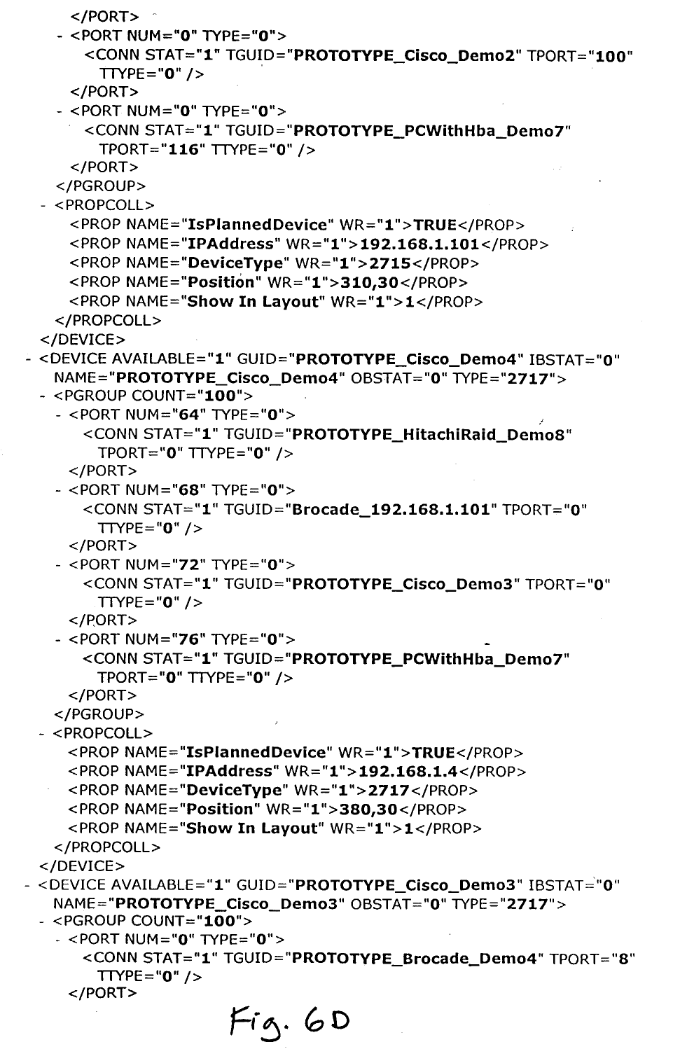

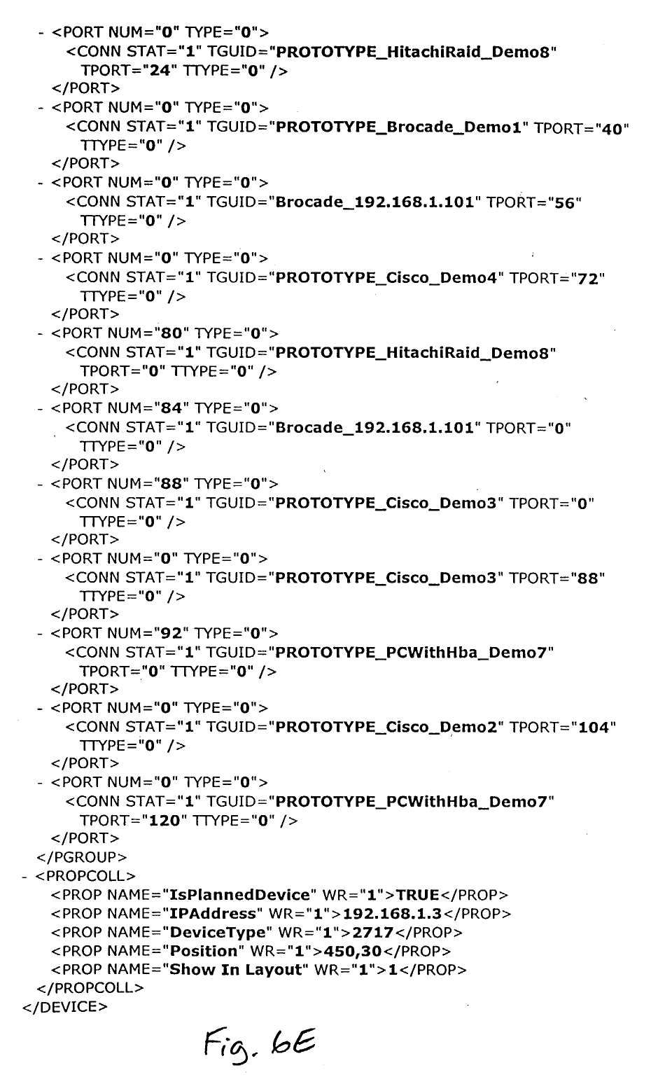

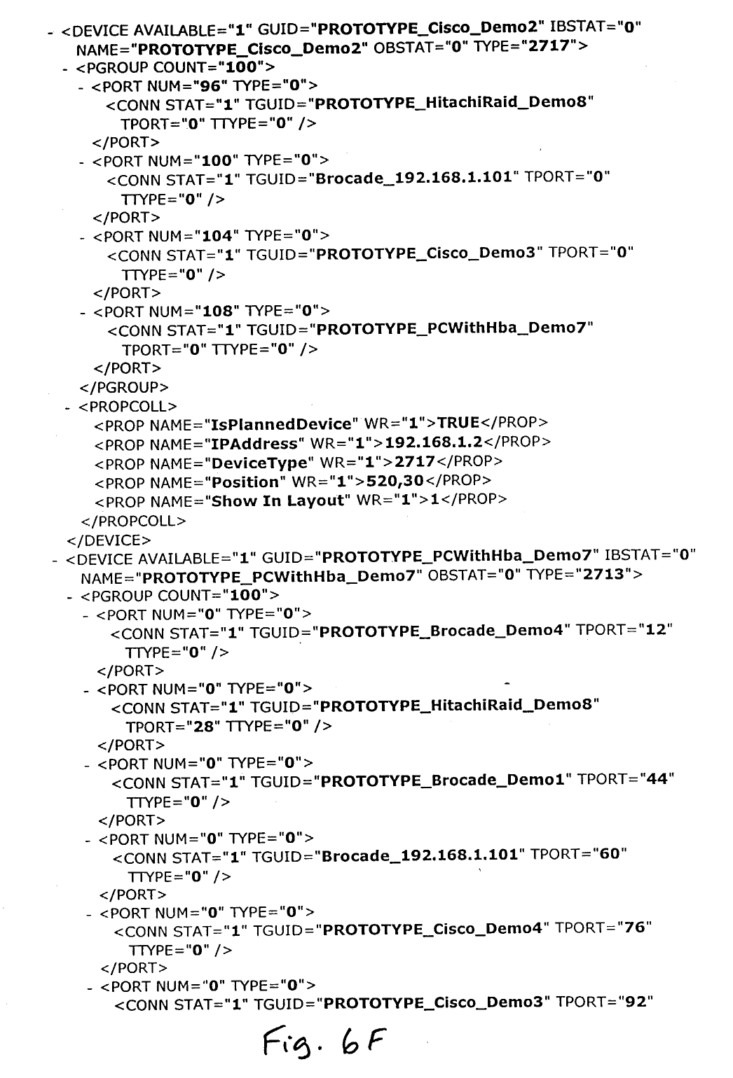

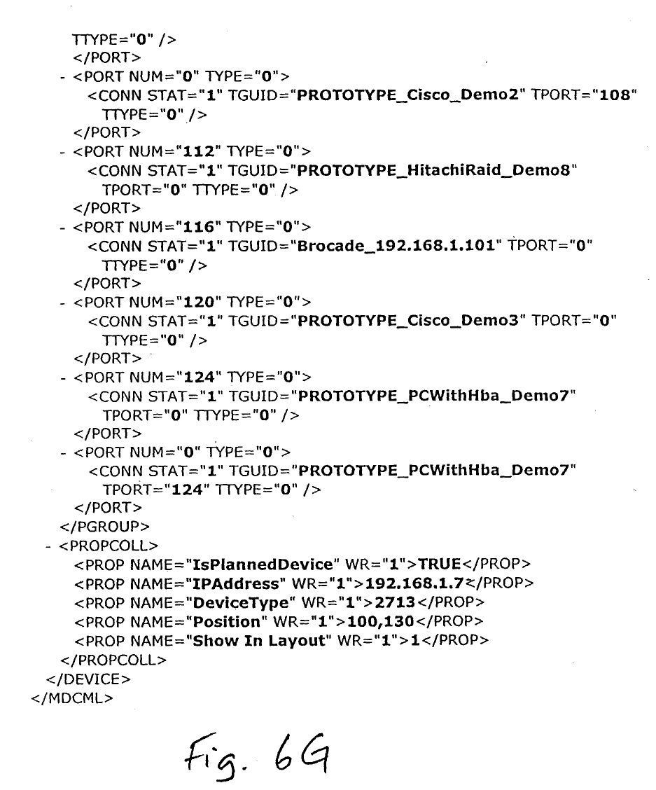

As described above, the LSM servers 110 collect respective device and topology information and forward such information to the GSM server 116. FIGS. 5A-C and 6A-G illustrate exemplary types of device and topology information that is forwarded by a LSM server 110 to the GSM server 116. In one exemplary implementation, the forwarded information is encoded in XML format. In turn, the GSM server 116 integrates all the device and topology information received from the LSM servers 110 and presents such integrated information for viewing and management purposes.

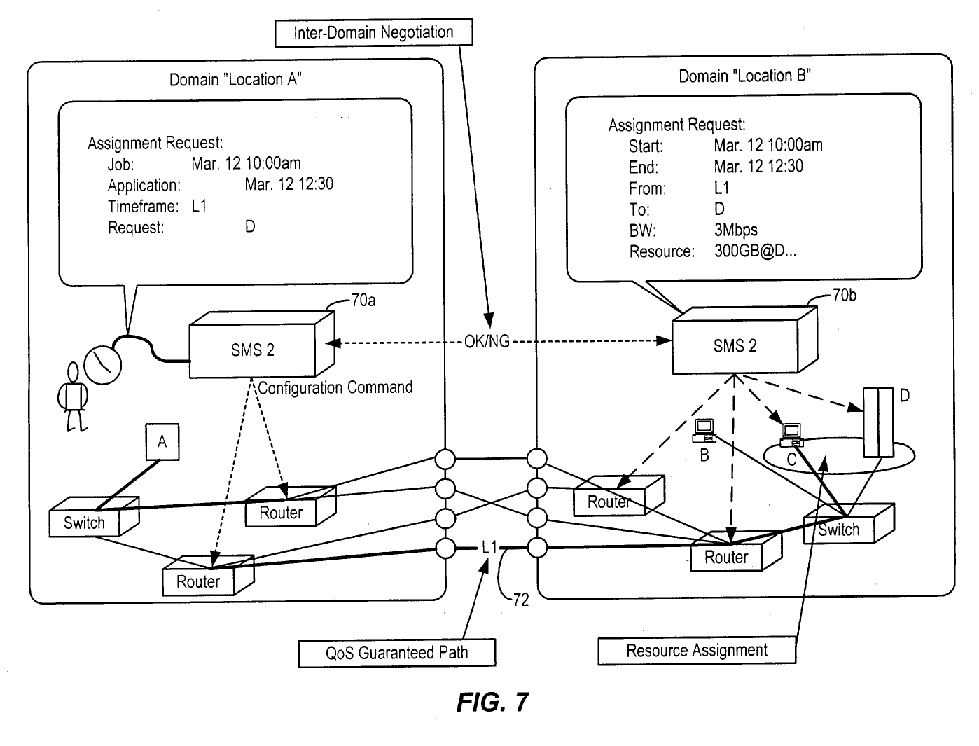

FIG. 7 illustrates the operations of one exemplary embodiment of the present invention. As shown in FIG. 7, there are two management domains, domain location A and domain location B. For purposes herein, a management domain is defined as a logical and physical area having resources that are under the management and control of a system administrator. Furthermore, each management domain also includes a system management (SM) server. One of the functions of the SM server is to allow a user, such as a system administrator, to manage and control resources under an associated management domain. Resources managed by the SM server under an associated management domain may include a variety of components or equipment, such as, a network node, a storage node, routers, switches, etc. In addition, the SM server also functions to permit communications with the corresponding SM server of other management domains. Communications between SM servers may be conducted via a private computer network. A variety of information may be communicated between two SM servers. For instance, a SM server may forward resource utilization and availability information relating to its associated management domain to another SM server. As will be further demonstrated below, SM servers periodically exchange information amongst themselves to facilitate and optimize resource utilization. In addition, as between two management domains, there are certain pre-coordinated or pre-established connections or linkage between the two management domains. These connections or linkage allow communications to be conducted between the two management domains.

For example, in FIG. 7, domain location A includes a number of interconnected components such as a switch, two routers and a storage node. These components are controlled and managed by SM server 70a; similarly, domain location B includes a number of interconnected components such as a switch, two routers and a network node, which are controlled and managed by SM server 70b. SM servers 70a and 70b also communicate with each other to determine the most optimal way to collectively utilize their respective resources. In one exemplary embodiment, the SM server may be implemented as part of a LSM server. Furthermore, pre-coordinated connections 72 are established between domain locations A and B to permit communications therebetween.

For each management domain, a user, such as a system administrator, is able to initiate a request with the associated SM server to specify and request resources that are needed for a particular job or process. Alternatively, a request may be forwarded from one SM server associated with a management domain to a second SM server associated with another management domain. In either event, upon receiving the request, the SM server evaluates the request and determines how to satisfy the request using resources within the management domain associated with the SM server as well as from other management domains, if appropriate.

In some situations, the SM server may determine that the request cannot be satisfied. In other situations, the SM server may determine that it is desirable to satisfy the request with resources solely from within its associated management domain. In yet other situations, the SM server may determine that resources from one or more other management domains are needed. The SM server may get the needed resources from other management domains in a number of ways.

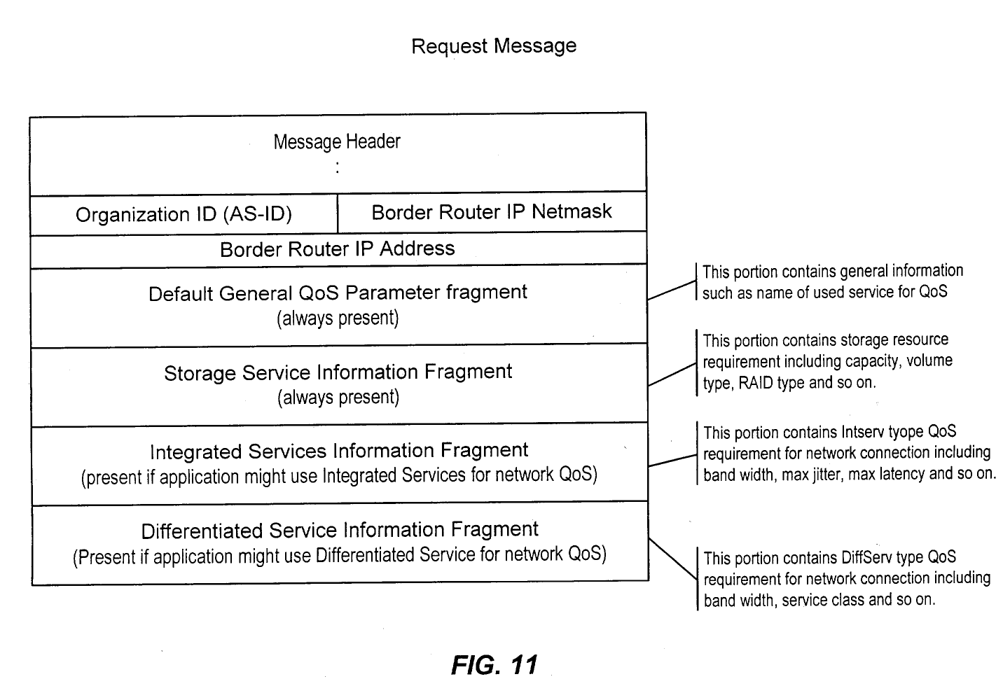

In one exemplary embodiment, the SM server may identify the needed resources from other management domains based on resource information received from the corresponding SM servers. Each SM server may periodically broadcast the resource information relating to its associated management domain to other SM servers. If the SM server determines that resources from other management domains are needed to satisfy the request, then the SM server initiates a negotiation process with the corresponding SM servers managing the other management domains by forwarding a request to these other SM servers. FIG. 11 is an illustrative diagram showing a sample request message that is forwarded by the SM server to another SM server to requesting additional resources. For purposes herein, a SM server that forwards a request to other SM servers to request additional resources may be referred to as a requesting SM server, and a SM server receiving a request may be referred to as a receiving SM server. The request forwarded by the requesting SM server to the receiving SM server includes, amongst other things, information as to what resources from the management domain associated with the receiving SM server are being requested and information relating to performance criteria that may need to be met by the requested resources.

Upon receiving the request, the receiving SM server communicates with the requesting SM server to determine whether the requested resources can be made available for use by the management domain associated with the requesting SM server. While resources associated with a management domain may be shown to be available, there may be different reasons why such resources may not be made available to other management domains. The receiving SM server may take a number of different actions with respect to the request. For example, the receiving SM server may decide to make all or some of the requested resources available, offer to substitute all or some of the requested resources with other available resources, or refuse to make any of the requested resources available. In addition, the negotiation process may also involve determining how to make the requested resources available via the pre-coordinated connections between the two management domains and have such resources meet certain specified performance criteria. For example, the requesting SM server may request that a storage node from the other management domain be able to accommodate a specified capacity and also be made available at a specified bandwidth via a dedicated connection, such as, a T1 or T3 trunk line. The negotiation process may continue back and forth between the requesting SM server and the receiving SM server until a solution or a resource assignment plan is reached. The resource assignment plan includes a variety of information, such as, what negotiated resources are to be made available and how such resources are to be provided. When the negotiation process is concluded, the SM server associated with each management domain begins to execute its resource assignment plan and deploy the appropriate resources within the management domain.

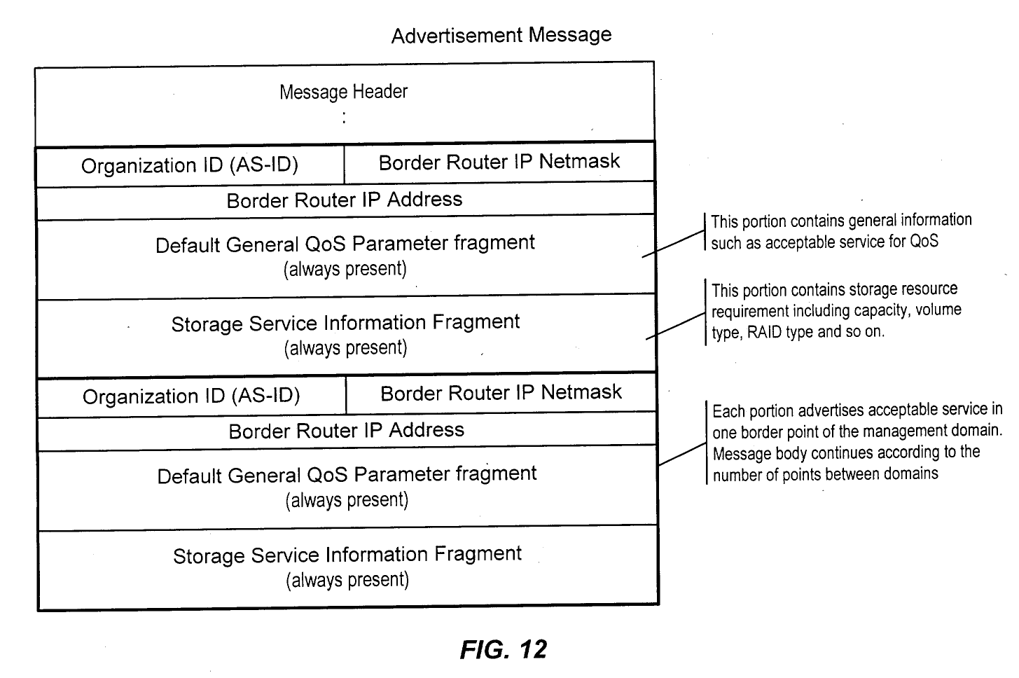

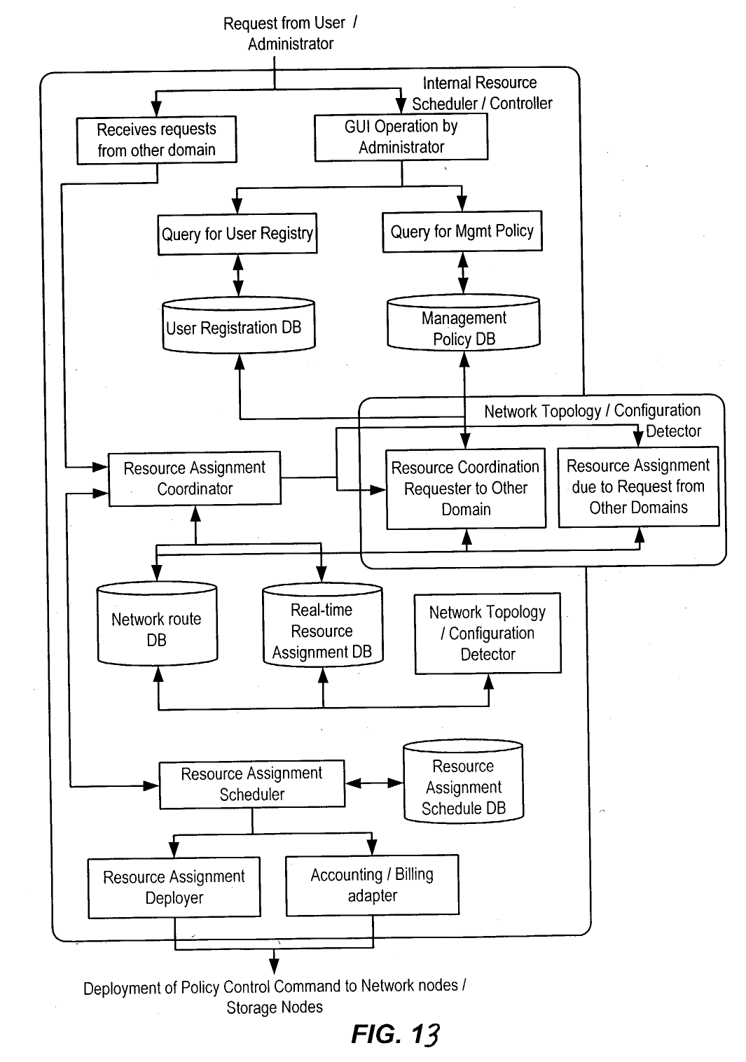

Alternatively, a requesting SM server may satisfy its need for additional resources from other management domains by broadcasting a request to other SM servers. FIG. 12 is an illustrative diagram showing a sample advertisement message that is broadcasted by a requesting SM server to other SM servers. One or more of these other SM servers may be able to satisfy all or part of the request. Each of these SM servers that are capable of satisfying the request may then respond by informing the requesting SM server of its resource availability. Likewise, a negotiation process similar to the one described above is initiated between the requesting SM server and each of the responding SM servers to develop and execute a resource assignment plan. FIG. 13 is a flow diagram illustrating an exemplary process under which resource requests are satisfied in accordance with the present invention.

FIG. 8 illustrates an exemplary embodiment of the SM server 70 in accordance with the present invention. As shown in FIG. 8, the SM server 70 further includes a number of components or modules including a communication manager 80, a policy server 82, a resource manager 84 and a resource database 86.

The communication manager 80 coordinates and controls communications amongst various resources within the associated management domain. The communication manager 80 also communicates with other communication managers to handle incoming and outgoing communications with other management domains.

The resource manager 84 is capable of managing both network and storage resources. With respect to managing network resources, the resource manager 84 monitors and controls all the network and network-related resources within the associated management domain and maintains the corresponding network information, such as, routing and utilization information. With respect to managing storage resources, the resource manager 84 monitors and controls all the storage and storage-related resources within the associated management domain and maintains the corresponding storage information, such as, access path control, routing and capacity information. In order to interact with the resource manager 84 or other modules within the SM server, some of the resources within the management domain may need to be modified to include functions that allow the SM server to ascertain the status information of these resources. For example, a storage node may include functions that notify the SM server when certain conditions or events occur, such as, device failure, configuration change or capacity overflow, etc.

The resource database 86 is a database that is used to store information and data utilized by the various modules of the SM server 70.

The policy server 82 evaluates any request initiated by a user, such as a system administrator, requesting resources for a particular job or process and determines whether and how the request can be satisfied. For example, the policy server 82 may maintain a table that specifies the varying authority levels of different users. Some users may be authorized to request certain resources while others are not. In addition, the policy server 82 also evaluates any request received from a requesting SM server and facilitates the negotiation process with the requesting SM server to determine the available resources, if any, that are to be offered to satisfy the request and finalize the resource assignment plan. For example, the policy server 82 may maintain a table that specifies the different resource availability levels for different management domains. More resources may be made available for some management domains. The policy server 82 further executes the resource assignment plan to deploy the assigned resources within the associated management domain. Details with respect to the policy server 82 will be further provided below.

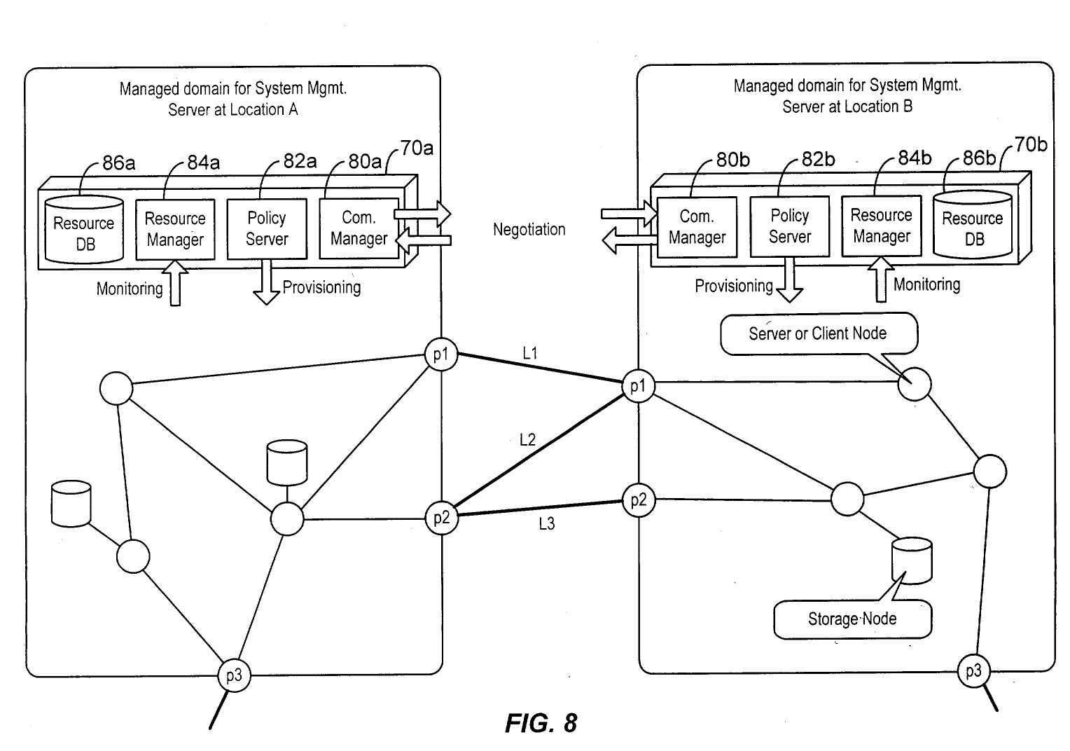

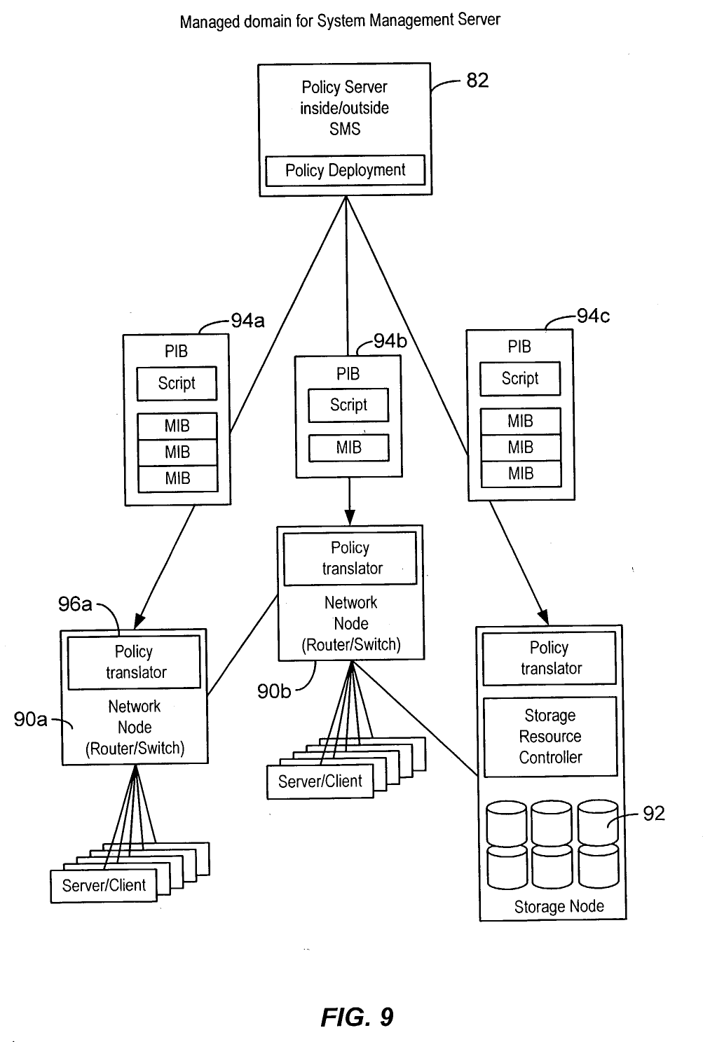

FIG. 9 illustrates an exemplary embodiment of the policy server 82 in accordance with the present invention. As shown in FIG. 9, the policy server 82 interacts with various resources within the associated management domain including, for example, network nodes 90 and storage nodes 92. The resource assignment plan may be formulated based on the Policy Information Base (PIB) 94 which, in an exemplary embodiment, is based on the policy-based management framework defined by the IETF. Each PIB 94 includes terms and conditions that define a specific policy. Each PIB 94 can be translated to the proprietary control commands that are specific to each resource that accepts the associated policy. In an exemplary embodiment, a PIB 94 may be described as a series of Management Information Base (MIB) parameters.

For example, as shown in FIG. 9, the PIB 94a may be translated via a policy translator 96a associated with the network node 90a. This translation allows the policy embodied in the PIB 94a to be converted to corresponding control commands that are specific to the particular configuration of the network node 90a. These control commands can then be used to interact with the network node 90a. The use of PIB and MIB is commonly known in the art and based on the disclosure and teachings provided herein, it will be clear to a person of ordinary skill in the art as to how PIB and MIB may be used to implement the present invention.

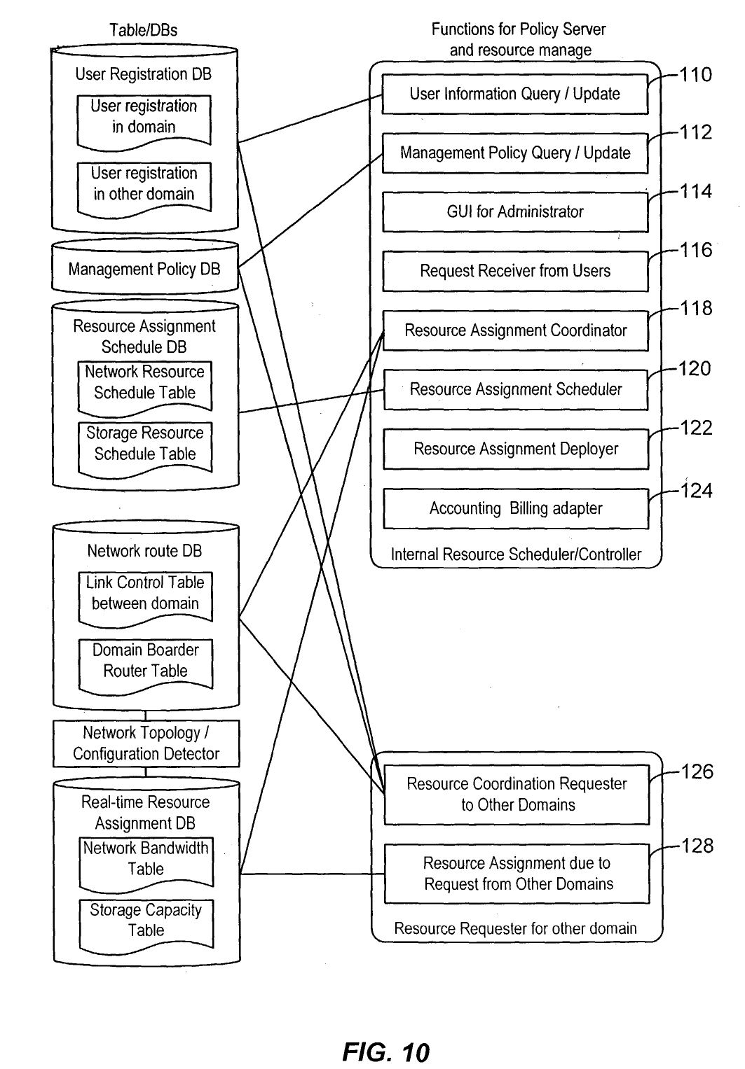

FIG. 10 illustrates some of the exemplary functions performed by the policy server 82, the resource manager 84 and the communication manager 80 within the SM server 70 and the respective databases with which they interact. It should be understood that these functions may be implemented and distributed within various components of the SM server 70. As shown in FIG. 10, the policy server 82 maintains user information 110 that is used to determine whether a request specified by a particular user is authorized. In other words, this is done to ensure that the request is legitimate. In some applications, for example, only selected users may be authorized to request the resources identified in the request. As mentioned above, a request may be initiated by a user at a management domain via a graphical user interface 114, or a request that is initiated by one user at one management domain may be forwarded to another management domain for purposes of requesting additional resources. When forwarded from one management domain to another, the request is received by a request receiver 116. In either event, the policy server 82 determines whether the user initiating the request is authorized to make such request. For example, a user may not be authorized to request certain resources at a particular management domain.

The policy server 82 also maintains management policy 112 with respect to the resources within the associated management domain. For example, at a particular management domain, only a limited amount of resources may be offered for use by other management domains. This policy may be implemented to ensure proper resource allocation or, conversely, avoid excessive or overextended use of resources by other management domains.

As described above, the resource manager 84 manages the resources within a management domain. The resource manager 84 cooperates with the policy server 82 to determine what and when resources, if any, are available to satisfy a request and deploy such resources accordingly and in a timely manner. For example, a resource assignment coordinator 118 is used to determine what resources are available to satisfy a request and assign such resources to satisfy the request; a resource assignment scheduler 120 is then used to schedule when the available resources are to be assigned to satisfy the request; and a resource assignment deployer 122 is used to deploy the assigned resources at their respective scheduled times to satisfy the request. Furthermore, at each management domain, an accounting and/or billing adapter 124 may be implemented to keep track of resource usage by other management domains. Finally, the communication manager 80 coordinates the processing of incoming and outgoing requests 126 and 128.

FIG. 10 also shows a number of databases or tables are used by the various exemplary functions. In an exemplary embodiment, the databases as shown in FIG. 10 are stored in the resource database 86.

The present invention can be deployed in a number of applications. For example, in one exemplary embodiment, the present invention can be used in an archive application. Referring back to FIG. 7, assume that data is created by a network node located in domain location A. This data is to be archived for backup and redundancy purposes, preferably, at a location domain that is separate from domain location A, like, for example domain location. To achieve this archive function, the requesting SM server at domain location A forwards a request to the corresponding receiving SM server at domain location B. The request includes a variety of information, such as, what type of storage device is desired, how much capacity is needed and how much bandwidth is required to transmit the data.

Upon receiving the request, the receiving SM server at domain location B begins the negotiation process with the requesting SM server at domain location A. Various details are negotiated between the requesting and the receiving SM servers. For example, domain location B may not have the type of storage device that the requesting SM server was looking for. Therefore, the receiving SM server may respond by offering a different type of storage device to the requesting SM server. The requesting SM server may find the offered substitute sufficient and accept the offered substitute. Similarly, other details are negotiated between the two SM servers.

Upon conclusion of the negotiation process, the two SM servers agree to a resource assignment plan. The receiving SM server executes the resource assignment plan and deploys the assigned resources. In this instance, data from domain location A can then be transferred to and stored at domain location B for archive purposes. Based on the disclosure and teachings provided herein, a person of ordinary skill in the art will know of other ways and/or methods to deploy the present invention in other applications.

It should be understood that the present invention as described herein can be implemented in software, in a modular or integrated manner, hardware or a combination of both. Based on the disclosure and teachings provided herein, a person of ordinary skill in the art will know of ways and/or methods to implement the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A system for facilitating resource utilization across multiple domains, comprising:
a plurality of domains, each domain having a plurality of resources;
a plurality of system management servers, each system management server being associated with a corresponding domain, each system management server configured to manage the plurality of resources associated with the corresponding domain and to process a request;
wherein the system management server evaluates the request to determine if resources associated with other domains are needed to satisfy the request;
wherein if resources associated with other domains are needed, the system management server begins a negotiation process with each of the other domains to secure the respective resources associated with the other domains for use by the domain associated with the system management server.

2. The system of claim 1 wherein if resources associated with other domains are needed, the system management server issues a broadcast message to other system management servers seeking to identify domains that are able to provide the needed resources.

3. The system of claim 1 wherein the plurality of resources associated with a domain include a network node and a storage node.

4. The system of claim 1 wherein the request is originated by a user;
wherein the system management server checks user information related to the user to determine whether the request is authorized.

5. The system of claim 1 wherein the request is originated by another system management server associated with another domain;
wherein the system management server evaluates the request to determine if resources from the domain associated with the system management server are needed to satisfy the request;
wherein if resources from the domain associated with the system management server are needed, the system management server checks a management policy to determine if such resources are to be made available to satisfy the request.

6. The system of claim 1 wherein the negotiation process involves negotiation relating to type and amount of resources to be made available, performance criteria and bandwidth requirements.

7. The system of claim 1 wherein each of the plurality of system management servers periodically forwards resource information to other system management servers.

8. The system of claim 1 wherein the system management server further comprises:
a communication manager configured to control communications amongst the plurality of resources under the domain associated with the system management server, the communication manager further configured to handle incoming and outgoing communications with other domains;
a resource manager configured to manage the plurality of resources under the domain associated with the system management server; and
a policy server configured to evaluate the request and determine if and how the request is to be satisfied.

9. A system for facilitating resource utilization between two domains, comprising:
a first domain having a first plurality of resources;
a second domain having a second plurality of resources;
a first system management server and a second system management server respectively associated with the first domain and the second domain, each system management server configured to manage the plurality of resources associated with the corresponding domain and to process a request;
wherein the first system management server evaluates the request to determine if resources outside of the first domain are needed to satisfy the request;
wherein if resources outside of the first domain are needed to satisfy the request, the first system management server contacts the second management server and begins a negotiation process with the second management server to secure resources from the second domain for use by the first domain.

10. The system of claim 9 wherein if resources outside of the first domain are needed, the first system management server issues a broadcast message to the second system management server seeking to determine if the second domain is able to provide the needed resources.

11. The system of claim 9 wherein the first plurality of resources and the second plurality of resources each includes a network node and a storage node.

12. The system of claim 9 wherein the request being evaluated by the first management server is originated by a user;
wherein the first system management server checks user information related to the user to determine whether the request is authorized.

13. The system of claim 9 wherein if the request being evaluated by the first system management server is originated by the second system management server, the first system management server checks a management policy to determine if any of the first plurality of resources is to be made available to satisfy the request.

14. The system of claim 9 wherein the negotiation process involves negotiation relating to type and amount of resources to be made available, performance criteria and bandwidth requirements.

15. The system of claim 9 wherein the first system management server and the second system management server periodically exchange resource information with each other.

16. A system for facilitating resource utilization across multiple domains, comprising:
a plurality of domains, each domain having a plurality of resources, one or more of the plurality of resources each including a network node and a storage node;
a plurality of system management servers, each system management server being associated with a corresponding domain, each system management server configured to manage the plurality of resources associated with the corresponding domain and to process a request;
wherein the plurality of system management servers periodically exchange resource information related to their corresponding domains amongst one another;
wherein a first system management server evaluates a first request to determine if resources outside of the domain associated with the first system management server are needed to satisfy the first request;
wherein if resources outside of the domain associated with the first system management server are needed to satisfy the first request, the first system management server begins a negotiation process with one or more of the remaining domains to secure resources needed to satisfy the first request.

17. The system of claim 16 wherein the first request is initiated by a user;
wherein the first system management server checks user information related to the user to determine whether the first request is authorized.

18. The system of claim 16 wherein if resources outside of the domain associated with the first system management server are needed to satisfy the first request, the first system management server determines which one or more of the remaining domains are able to provide the resources needed to satisfy the first request using the resource information received from the remaining domains.

19. The system of claim 16 wherein if resources outside of the domain associated with the first system management server are needed to satisfy the first request, the first system management server issues a broadcast message to the remaining domains seeking to determine if any of the remaining domains is able to provide the needed resources.

20. The system of claim 16 wherein if the first request is originated by another domain, the first system management server checks a management policy to determine if any of the plurality of resources under the domain associated with the first system management server is to be made available to satisfy the first request.

21. The system of claim 16 wherein the negotiation process involves negotiation relating to type and amount of resources to be made available, performance criteria and bandwidth requirement.
